(19) United States
(12) Patent Application Publication
(10) Pub. No.: US 2007/0006280 A1
(43) Pub. Date: Jan. 4, 2007

(54) Security management apparatus for office appliance, security management method for office appliance and security management program for office appliance

(75) Inventor: Toshiharu Takahashi, Tokyo (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/231,207

(22) Filed: Sep. 19, 2005

(30) Foreign Application Priority Data
Jan. 11, 2005 (JP) 2005-3544

(51) Int. Cl. H04L 9/00

(52) U.S. Cl. 726/1

(57) ABSTRACT

There is disclosed a security managing apparatus and so on that are to be used for an office appliance in order to enhance the degree of freedom of security management of the office appliance to thereby improve the security and the operability of the office appliance. The security management apparatus for an office appliance such as an MFP having a plurality of job features comprises a security feature setting section that sets a security feature corresponding to each job feature and a security feature executing section that executes the security feature set by the security feature setting section at the time of job execution corresponding to the job to be executed.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### RELATED APPLICATION INFORMATION

This patent is related to, which is incorporated herein by reference.

### BACKGROUND OF THE INVENTION

1. Field of the Invention

The present invention relates to a security management apparatus, a security management method and a security management program to be used for an office appliance such as an MFP (multi function peripheral) having a plurality of job features. For the purpose of the present invention, office appliances include copying machines, scanners, printers, fax machines and PCs that operate as image processing apparatus.

2. Description of the Related Art

Office appliances having a security feature of erasing the data that are once stored therein for the purpose of prevention of leakage of information are known. For example, a technique of providing a video data erasing section that is equipped with a section that controls the number of times of erasing operations to be performed by the video data erasing section so as to allow the user to arbitrarily select the number of times of erasing the video data to be erased, considering the security level required for each processing mode in which the video data to be erased are output is disclosed (refer to, for example, Japanese Patent Application Laid-Open Publication No. 2004-153516).

However, office appliances, MFPs in particular, have been made to show complex job features in recent years so that it is no longer satisfactory if they have a security feature of simply erasing data. On the other hand, the demand for the use of such security features on the part of users of office appliances can vary significantly depending on the job features in question and from user to user and also from job to job, although the varied demand has to be met. Additionally, while such security features need to be improved and expanded, it is also desires to reduce the lowering of the proper job processing speed.

### SUMMARY OF THE INVENTION

In view of the above identified problems, it is therefore the object of the present invention to provide a security management apparatus and so on that are to be used for an office appliance in order to enhance the degree of freedom of security management of the office appliance to thereby improve the security and the operability of the office appliance.

In an aspect of the present invention, the above object is achieved by providing a security management apparatus for an office appliance having a plurality of job features, the apparatus comprising a security feature setting section that sets a security feature corresponding to each job feature and a security feature executing section that executes the security feature set by the security feature setting section at the time of job execution corresponding to the job to be executed.

In another aspect of the present invention, there is provided a security management method for managing the security of an office appliance having a plurality of job features, the method comprising a security feature setting step that sets a security feature corresponding to each job feature and a security feature executing step that executes the security feature set in the security feature setting step at the time of job execution corresponding to the job to be executed.

In still another aspect of the present invention, there is provided a security management program for having the computer of an office appliance having a plurality of job features set a security feature so as to manage the security of the office appliance, the program comprising a security feature selecting step that presents security features corresponding to each job feature and has a security feature selected and a managing step that registers and manages the security feature selected in the security feature selecting step to be executed by the computer of the office appliance.

As defined in detail above, according to the invention, there are provided a security management apparatus, a security management method and a security management program that are to be used for an office appliance in order to enhance the degree of freedom of security management of the office appliance to thereby improve the security and the operability of the office appliance.

### DESCRIPTION OF THE DRAWINGS

FIG. 1 is a schematic block diagram of an image forming apparatus (MFP) to which an embodiment of the present invention is applied, illustrating the configuration thereof.

FIG. 2 is a schematic conceptual illustration of the hard disk of the image forming apparatus of FIG. 1, illustrating the configuration thereof.

FIG. 3 is a flow chart of the operation of setting a security feature for each job feature (a security feature setting operation for each job feature).

FIG. 4 is a schematic illustration of a security feature setting image to be used for setting a security feature for each job feature.

FIG. 5 is a table for managing security features for the user.

FIG. 6 is a table for managing specific security features for the user.

FIG. 7 is a flow chart of the operation of setting a security feature for each job (security feature setting operation for each job).

FIG. 8 is a schematic illustration of a security feature setting image to be displayed on a display panel when setting a security feature for each job.

FIG. 9 is a table for managing jobs.

FIG. 10 is a schematic illustration of a UI image of a printer driver on the display screen of a PC.

FIG. 11 is a flow chart of the operation of executing a copying feature as job feature.

FIG. 12 is a flow chart of a file writing routine.

FIG. 13 is a flow chart of a file reading routine.

FIG. 14 is a flow chart of a file deleting routine.

### DETAILED DESCRIPTION OF THE INVENTION

Now, the present invention will be described in greater detail by referring to the accompanying drawings that illustrate preferred embodiments of the invention.

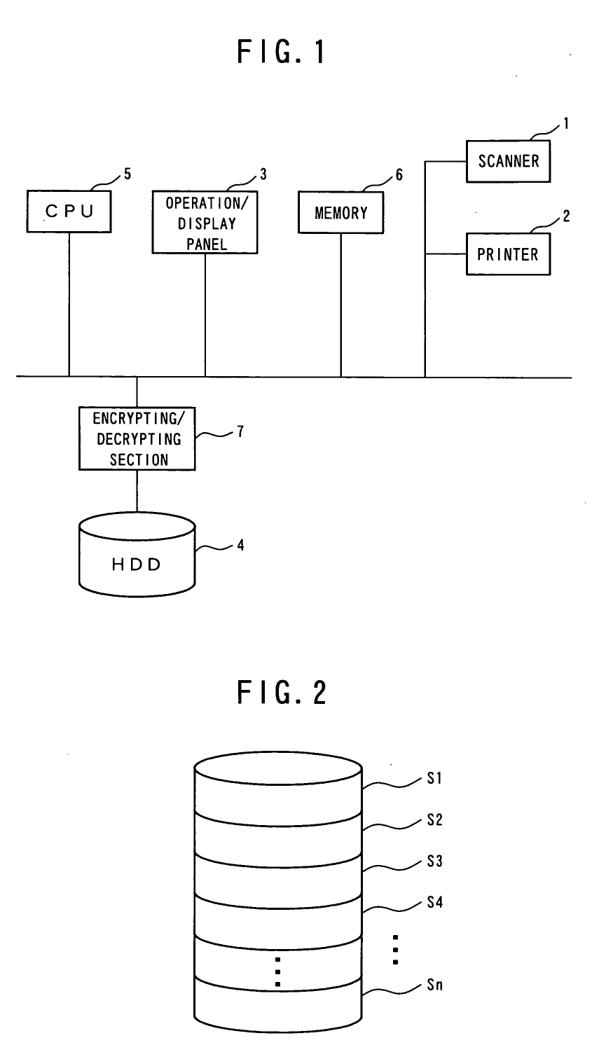

FIG. 1 is a schematic block diagram of an image forming apparatus (MFP) to which an embodiment of the present invention is applied, illustrating the configuration thereof and FIG. 2 is a schematic conceptual illustration of the hard disk drive (HDD) of the image forming apparatus of FIG. 1, illustrating the configuration thereof.

The image forming apparatus to which an embodiment of the present invention is applied comprises a scanner 1, a printer 2, an operation/display panel 3, an HDD 4, a CPU 5 and a memory 6 along with an encrypting/decrypting section 7 for encrypting, if necessary, the data to be stored in the HDD 4 and decrypting them when reading it out.

The storage area of the HDD 4 is divided into a plurality of partitions S1 through Sn so as to correspond to a plurality of security features (e.g., encryption, erasure, etc.), which will be described in greater detail hereinafter. The data that have been processed for a corresponding security feature by the CPU 5 and a program, which will be described in greater detail hereinafter, are stored in a partition of the HDD 4 and read out from the partition. The CPU 5 and the program, which will be described in greater detail hereinafter, form a stored data management section for the purpose of the present invention. It is possible to raise the data processing speed by the arrangement that the data processed for a security feature are stored in a corresponding partition.

(Setting a Security Feature for Each Job Feature)

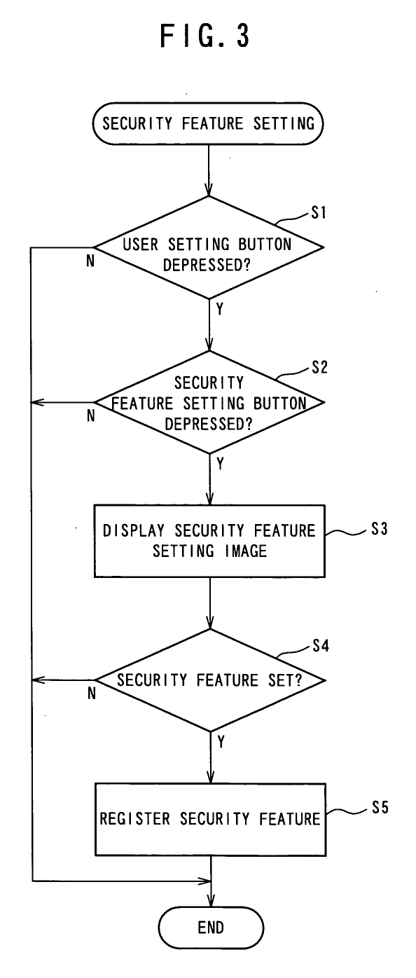

Now, the operation of setting a security feature for each job feature will firstly be described by referring to the flow chart of FIG. 3 for this embodiment.

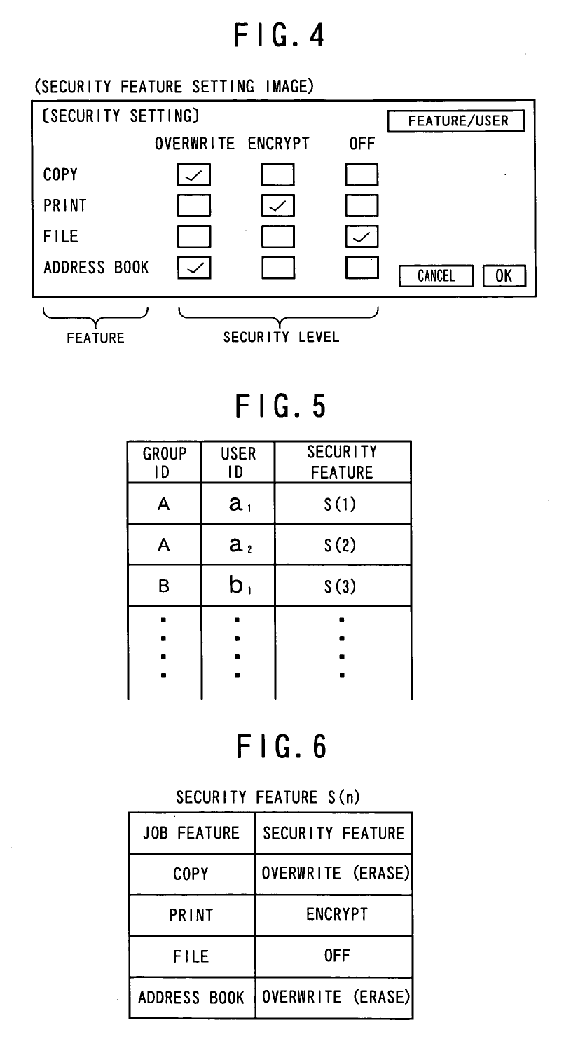

Firstly, as the user setting button is depressed to set the user (S1, Y) and the security feature setting button is depressed to set a security feature (S2, Y), a security feature setting image as shown in FIG. 4 is displayed in Step S3.

Referring to FIG. 4, a number of security features including “overwrite”, “encryption” and so on are displayed in the security feature setting fields to correspond to a plurality of job features including “copy”, “print”, “file”, “address book” and so on. As the user depresses one of the fields he or she wants, he or she selects the corresponding security feature for a job feature and, as the user depresses the OK button, he or she sets the selected security feature for use. If the user does not want any security feature, he or she selects the corresponding “off” field and depresses the “OK” button.

As the OK button is depressed, the CPU 5 recognizes in Step S4 that a security feature is specified (S4, Y) and registers the specified security feature in the memory (S5). Then, as the user selects a job feature, the CPU 5 realizes the security feature selected for the job feature, while it executes the process for the job feature.

FIGS. 5 and 6 are management tables for managing security features. More specifically, FIG. 5 is a table for managing security features for the user and FIG. 6 is a table for managing specific security features shown in FIG. 5. Thus, in this embodiment, a security feature is set for each combination of a user and a job feature and managed.

In the above described arrangement, Steps S1 through S5 are operations of a security feature setting section for setting a security feature for a job feature for the purpose of the present invention. More specifically, Step S1 is an operation of a user registration section (or step) and Steps S3 and S4 are security feature selecting steps, while Step S5 is a managing step for the purpose of the present invention.

(Setting a Security Feature for Each Job)

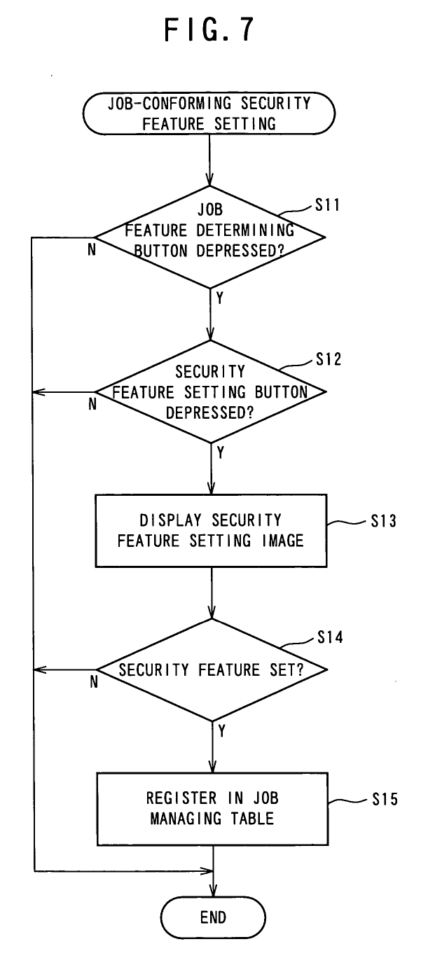

Now, the operation of setting a security feature, if necessary, each time a job is executed (job-conforming security feature setting operation) will be described by referring to the flow chart of FIG. 7 as another mode of operation.

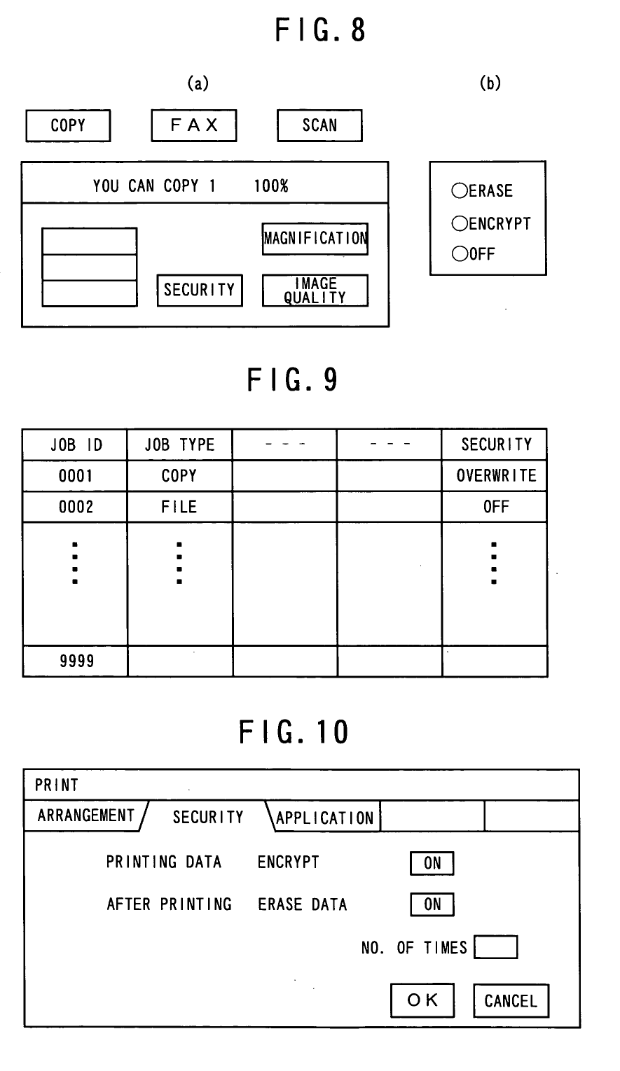

Firstly, as a job feature specifying button is depressed out of a plurality of job feature specifying buttons such as “copy” “FAX”, “scan” and so on arranged on the display panel as shown in FIG. 8 (S11, Y), it is determined in Step S12 if the security feature setting button is depressed or not. If, for example, “copy” is selected as job feature, an image relating to the copy feature is displayed as shown (a) of FIG. 8 and it is determined if “security” button is depressed or not.

If it is determined that the security feature setting button is depressed (S12, Y), a security feature setting image as shown in (b) of FIG. 8 is displayed (S13). The security feature setting image shows the types of available security features and, provided that one of the type of available security features is selected (S14, Y), the selected security feature is registered (S15) and the selected security feature is executed for the job. FIG. 9 illustrates the table for managing the registered jobs. In other words, the security features that correspond to the respective jobs are registered on the table.

While FIG. 8 illustrates an occasion where “copy” is selected, if “print” is selected, it is possible to set a security feature on the UI image for the printer driver that is displayed on the PC as shown in FIG. 10. In such a case, it is possible to set security features such as encryption of the printing data for storage and erasure of the data after the printing operation.

The job-conforming security feature setting feature can be set independently from the security feature that is set for each job feature as shown in FIG. 3. If the two features differ from each other, it is preferable to give priority to the latter. In such a mode of realizing the present invention, it is possible to switch or cancel the security feature that is set corresponding to a job feature by the user on a job by job basis. An user who has not complete user setting can also use the security feature without passing through the process of FIG. 3.

In the above description, Steps S11 through S14 are operations of a job-conforming security feature setting section and a security feature selecting step for the purpose of the present invention and Step S15 is a managing step for the purpose of the present invention.

For erasing data, it is possible to quickly erase data by overwriting the data to be erased with random number data, using a random number data generating function and raise the certainty of erasure according to the number of times of overwriting. In this embodiment, it is also possible to set the number of times of overwriting as a security feature for the purpose of erasing data.

Now, how the security feature that is set in a manner as described above is executed and how the security feature executing section or the job-conforming security feature executing section of the present invention is formed will be described below by way of an example of executing a job application for the copying feature.

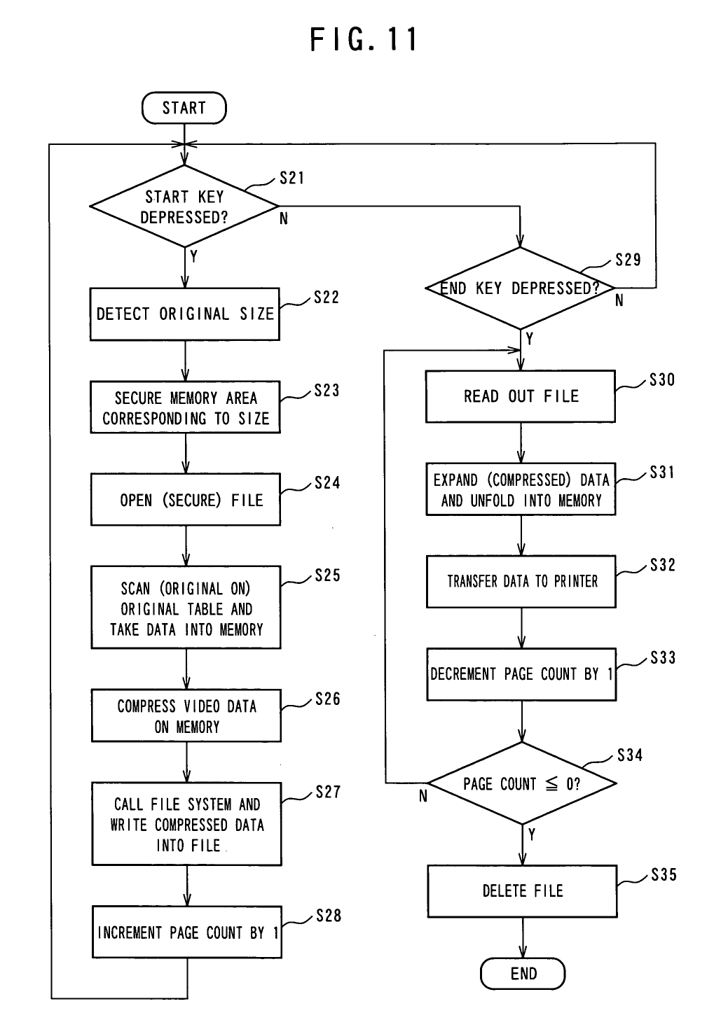

FIG. 11 is a flow chart of the operation of executing a copying feature as job feature. Firstly, as the start key is depressed (S21, Y), the CPU 5 detects the size of the original (S22) and secures a memory area that corresponds to the size of the original (S23). Then, the CPU 5 opens a file (S24). Subsequently, it acquires video data by scanning the original on the original table and takes the acquired video data onto the memory (S25). Then, it compresses the video data on the memory (S26) and calls the file system by means of a file write routine, which will be described in greater detail thereinafter, to write the compressed data onto the file (S27). Then, it increments the page count by one (S28) and returns to the start key.

When the end key is depressed (S21, N), (S29, Y), the CPU 5 reads out the file by means of a file read routine (S30), which will be described in greater detail hereinafter. Then, it expands the compressed data and unfolds them on the memory (S31). Thereafter, it transfers the data to the printer (S32) and decrements the page count by one (S33). Then, it repeats Steps S30 through S33 until the page count becomes equal to 0 (S34, Y) and deletes the file by a file delete routine (S35), which will be described in greater detail hereinafter.

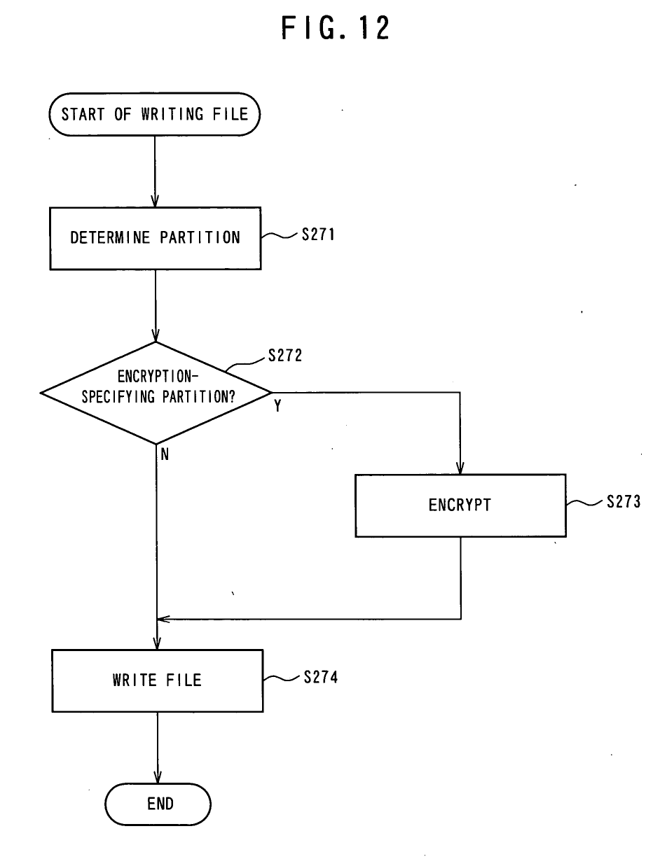

Now, the file write routing that is used in Step S27 will be described below by referring to FIG. 12. Firstly, the CPU 5 determines the partition in the HDD to be used for writing the data (S271). The partition can be determined by determining the security feature on the basis of the security feature managing tables as shown in FIGS. 5 and 6 or the job ID in the table shown in FIG. 9.

If the determined partition is an encryption-specifying partition (S272, Y), the CPU 5 encrypts the file by means of the encrypting section of the encrypting/decrypting section (S273) and writes the file into the partition. If, on the other hand, the determined partition is not an encryption-specifying partition (S272, N), the CPU 5 does not encrypt the file and writes the unencrypted file into the partition (S274) and ends the process of the routine.

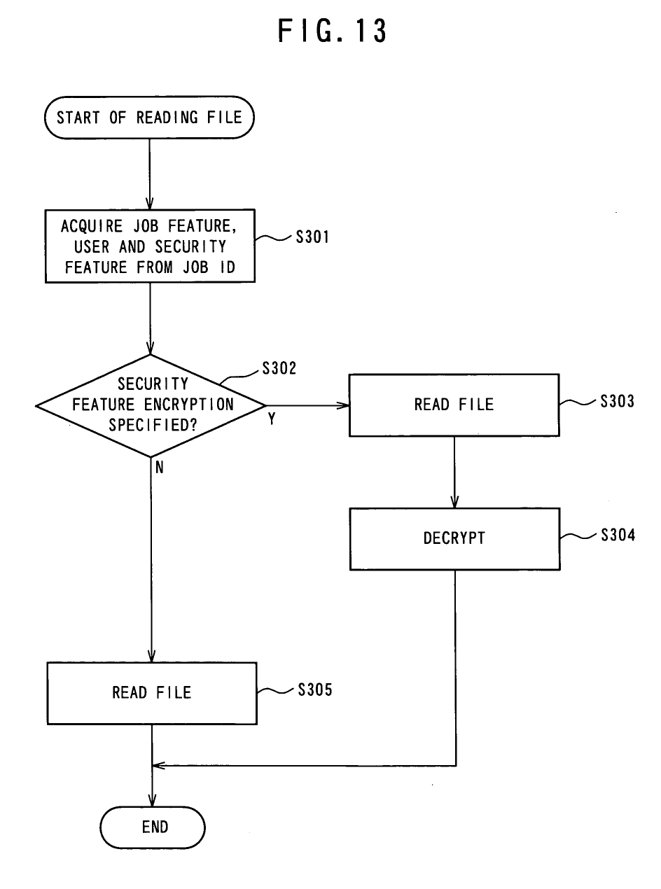

Now, the file read routine that is used in Step S30 will be described below by referring to FIG. 13. Firstly, the CPU 5 acquires the job feature, the user and the security level (security feature) from the job ID (S301). Then, the CPU 5 determines if the security feature is that of encryption or not (S302) and, if it is the security feature of encryption (S302, Y), it reads out the file (S303) and decrypts the file by means of the decrypting section of the encrypting/decrypting section (S304) to end the process. If, on the other hand, the security feature is not that of encryption (S302, N), the CPU 5 reads out the file without any decryption (S305) and ends the process.

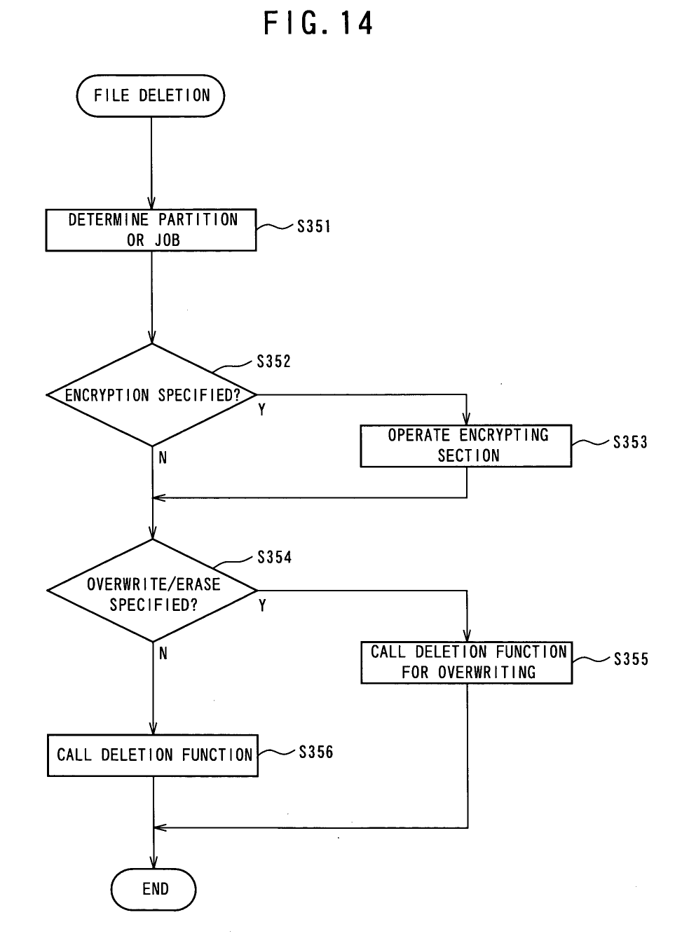

Now, the file delete routine that is used in Step S35 will be described by referring to FIG. 14. Firstly, the CPU 5 determines the partition (or job) relating to the process (S351). Then, if the partition is an encryption-related partition (encryption-specifying partition) (S352, Y), the CPU 5 operates the encrypting section (S353). Then, if erasure (overwrite/erase) is specified as security feature (S354, Y), the CPU 5 calls the deletion function for overwriting and overwrites to erase the data (S355). If, on the other hand, overwrite/erase is not specified as security feature (S354, N), the CPU calls the deletion function and erase the data (S356).

In the routines illustrated in FIGS. 12 through 14 for the above operations, Steps S272, Step S302 and Steps S352 and 354 form the security feature determining step for the purpose of the present invention, whereas Step S273, Step S304 and Steps S353 and S355 form the security feature executing section or the jog-conforming security feature executing section (step) for the purpose of the present invention.

While the features for carrying out the present invention in the inside of the apparatus may be recorded in a memory in advance in this embodiment, similar features may alternatively be downloaded to the apparatus from a network or may be installed in the apparatus from a recording medium storing similar features. Recording mediums that can be used for the purpose of the present invention include CD-ROMs that can store programs if the apparatus can read the program for such a storage medium. Still alternatively, the features that can be acquired by installing or downloading in advance may be realized as a result of cooperation with the OS (operating system) in the inside of the apparatus.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications and alterations should therefore be seen as within the scope of the present invention.

It is claimed:

1. A security management apparatus for an office appliance having a plurality of job features, the apparatus comprising:
a security feature setting section that sets a security feature corresponding to each job feature; and
a security feature executing section that executes the security feature set by the security feature setting section at the time of job execution corresponding to the job to be executed.

2. The apparatus according to claim 1, further comprising:
a user registering section that registers users;
the security feature setting section being adapted to set a security feature corresponding to the user registered by the user registering section along with the job feature;
the security feature executing section being adapted to execute the security feature set by the security feature setting section corresponding to the user relating to the execution of the job and the job.

3. The apparatus according to claim 1, wherein
the security feature setting section has a job-conforming security feature setting section that sets the desired security feature out of a plurality of security features provided to correspond to the job prior to the execution of the job; and
the security feature executing section has a job-conforming security feature executing section that executes the security feature set by the job-conforming security feature setting section at the execution of the job.

4. The apparatus according to claim 1, further comprising:
a stored data managing section that divides the memory region of the non-volatile memory for storing the data to be handled for the execution of the job for each of the security features and storing the data.

5. The apparatus according to claim 1, wherein
the security features include an erasing feature of overwriting data to erase them.

6. The apparatus according to claim 1, wherein
the security features include an encrypting feature of encrypting data.

7. A security management method for managing the security of an office appliance having a plurality of job features, the method comprising:
a security feature setting step that sets a security feature corresponding to each job feature; and
a security feature executing step that executes the security feature set in the security feature setting step at the time of job execution corresponding to the job to be executed.

8. The method according to claim 7, further comprising:
a user registering step that registers users;
the security feature setting step being adapted to set a security feature corresponding to the user registered by the user registering section along with the job feature;
the security feature executing step being adapted to execute the security feature set in the security feature setting step corresponding to the user relating to the execution of the job and the job.

9. The method according to claim 7, wherein
the security feature setting step has a job-conforming security feature setting step that sets the desired security feature out of a plurality of security features provided to correspond to the job prior to the execution of the job; and
the security feature executing step has a job-conforming security feature executing step that executes the security feature set in the job-conforming security feature setting step at the execution of the job.

10. A security management program for having the computer of an office appliance having a plurality of job features set a security feature so as to manage the security of the office appliance, the program comprising:
a security feature selecting step that presents security features corresponding to each job feature and has a security feature selected; and
a managing step that registers and manages the security feature selected in the security feature selecting step to be executed by the computer of the office appliance.

11. The program according to claim 10, further comprising:
a user registering step that registers users;
the managing step being adapted to register and manage the security feature selected in the security feature selecting step corresponding to the user registered in the user registering step.

12. The program according to claim 10, further comprising:
a job feature selecting step that selects the job feature to be executed out of a plurality of job features at the time of job execution;
the security feature selecting step including a job-conforming security feature setting step that selects and sets the security feature to be used for the job feature selected in the job feature selecting step at the time of executing the job feature.

13. The program according to claim 10, further comprising:
a job feature selecting step that selects the job feature to be executed out of a plurality of job features at the time of executing the job;
a security feature determining step that determines if the security feature selected in the security feature selecting step is managed in the managing step for the job feature selected in the job feature selecting step; and
a security feature executing step that executes the managed security feature to execute the job feature when the security feature is determined to be managed in the security feature determining step.
